(19) United States
(12) Patent Application Publication
(10) Pub. No.: US 2015/0356595 A1
(43) Pub. Date: Dec. 10, 2015

(54) ELASTICITY OF ENGAGEMENT TO AD QUALITY

(71) Applicant: Yahoo! Inc., Sunnyvale, CA (US)

(72) Inventors: Ram Sriharsha, Santa Clara, CA (US); Supreeth Hosur Nagesh Rao, Sunnyvale, CA (US)

(73) Assignee: YAHOO! INC., Sunnyvale, CA (US)

(21) Appl. No.: 14/297,054

(22) Filed: Jun. 5, 2014

(51) Int. Cl. G06Q 30/02

(52) U.S. Cl. CPC G06Q 30/0243; G06Q 30/0275

(57) ABSTRACT

Described herein are solutions for determining quality of online ads and matching the ads to content so that the content is not devalued by the ads. Such solutions may also identify relationships between ads and their influence on user engagement with host content. The solutions may also define and provide the relationships to advertisers, in forms of historical scores and projected scores. The historical scores may include historical elasticity scores and the projected scores may include projected elasticity scores. The scores may be determined per ad and content pair. The solutions can use the scores to influence ad pricing.

### BACKGROUND

This application relates to determining elasticity of engagement to ad quality. This application also relates to the automation of rating online ads.

Increasingly, advertising is being integrated with online content. Online audiences are demanding free content or at least content delivered at below market prices. Because of this demand, publishers and content networks may be delivering ads with such content to compensate for lost profits. It has also been found that advertising can be acceptable to online audiences if the advertising is useful to audience members or at least not an annoyance.

The common techniques of providing quality management to advertising is helpful but not well adapted to the scale of online advertising, especially considering the scale added and introduced by the mobile marketplace. There is, therefore, a set of engineering problems to be solved in order to provide advertising that is well adapted to mobile and non-mobile online environments, so that such advertising is useful or at least not irritating to audiences.

Resolution of such engineering problems is pertinent considering advertising ecosystems include advertisers who want their ads viewed and content publishers whose viewership rely on advertising not detracting from their content. The resolution of these technical issues can benefit content publishers that are willing to forego gaining short-term profits via obtrusive advertising for long-term viewers that will accept quality advertising. Also, advertisers can benefit from ad quality solutions in that such solutions may result in a greater number of user interactions with their advertising or at least the content that is hosting their advertising; and therefore, their advertising may appear for longer periods of time.

The novel technologies described herein set out to solve the problem of determining quality of ads on a large scale, such as a scale presented by online advertising. They also set out to solve the problem of matching ads to content that will not be devalued by the ads. With this last problem, included is the problem of determining the relationship between ads and their influence on engagement with host content. At this point, there has not been a viable solution to scale for resolving the aforementioned problems in an online advertising environment.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example system that can provide ad quality scores and scores defining the effect of an ad's quality on an online property, such as scores defining how change in ad quality can change user engagement with a host property (i.e., elasticity of engagement to ad quality scores). Hereinafter elasticity of engagement to ad quality scores is referred to as elasticity scores.

FIG. 2 illustrates displayed ad items and content items of example screens rendered by client-side applications.

FIGS. 3a and 3b illustrate example sets of graphed data points representative of elasticity scores.

FIG. 4 illustrates a block diagram of the example information system interacting with an example system that can provide ad quality scores, elasticity scores, and other types of scores related to effects of ad quality on user engagement with online properties.

FIGS. 5a and 5b illustrate example graphical user interfaces associated with an advertiser front end, displayed on an example client device.

FIGS. 6 and 7 are block diagrams of example electronic devices that can implement aspects of and related to example systems that can provide ad quality scores, elasticity scores, and other types of scores related to effects of ad quality on user engagement with online properties.

### DETAILED DESCRIPTION

Subject matter will now be described more fully hereinafter with reference to the accompanying drawings, which form a part hereof, and which show, by way of illustration, specific examples. Subject matter may, however, can be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview

The system described herein can determine quality of ads on a large scale, such as a scale presented by online advertising, and match such ads to content that will not be devalued by the ads. The system can also determine the relationship between ads and their influence on engagement with host content. They system can define and provide such a relationship to end-users, such as advertisers, in forms of historical scores and projected scores. These scores can include historical elasticity scores and projected elasticity scores per ad and content pair. The system can use the scores to influence ad pricing.

Described herein is a system that can determine and output a cost an ad or ad quality can have on user engagement with an online property, such as a website. The system can also provide how change in ad quality can change user engagement with a host property (i.e., elasticity of engagement to ad quality). Such a system can provide automated editorial oversight on ad quality with or without respect to host properties. The automation can ensure that undesirable ads are not shown to users unless an advertiser pays for the detraction caused by an ad. In some examples, an interfering ad may be prohibited from the property without the possibility to pay for the detraction.

The system may have two parts. The system may include a sub-system for determining ad quality in general or with respect to certain content, in the form of quality scores. The system may also include a sub-system for determining effects of ad quality on engagement with host properties, such as elasticity of engagement to ad quality.

With the first part, using historical ad quality scores, the system can determine a score for a newly created ad or at least an ad new to the system. This can be done by matching the ad to a historical ad or group of ads and then determining its quality score accordingly. The advantage of such a procedure is that with an increase in an amount of ads, the quality scores may become more effective at representing the actually quality of an ad in general and with respect to its effect on user engagement with certain content.

As mentioned, the system can also determine the effects of ads and their quality on user engagement with host properties, using ad quality scores on delivered ads and new ads yet to be delivered. The ad quality scores can also be used by the system to determine elasticity of engagement to ad quality. The effects of ads and their quality on user engagement with host properties can be determined using identification tags for a given ad and host property (i.e., an ad and property pair). These tags can be used to track (such as track within user session logs) various interactions with the ad and the property. The tracking of such interactions can be collected and analyzed through an analytics server, for example; and resulting analytics can be used as input to determine ad quality scores for ads and elasticity scores for ad and property pairs. For example, per ad and property pair, the system can track users who were shown the ad and the users' engagement metrics with the property hosting the ad. Engagement metrics can include retention rate, time spent per session on the property, and the like. Through such tracking, the system can determine ad quality metrics versus property engagement metrics for the ad and property pair. By relationships between these metrics, the system can determine an elasticity score for the ad and property pair. In an example, the elasticity score may be a determined by log linear relationship between change in engagement with the property and change in ad quality, for the pair. Also, the elasticity score can be derived from a linear regression of a curve or function representing a relationship between an ad quality metric and a property engagement metric. Besides determining elasticity scores per ad and property pair, the system can determine elasticity scores using similar methods per ad type and content type pair, ad type and particular property pair, particular ad and content type pair, or any combination thereof.

With the quality score determinations and/or elasticity score determinations, content networks and publishers can determine which ads to pull from their distributed content. Also, the networks and publishers can offer adjustments in pricing for ad booking based on the quality scores, elasticity scores, or both.

DESCRIPTION OF THE DRAWINGS

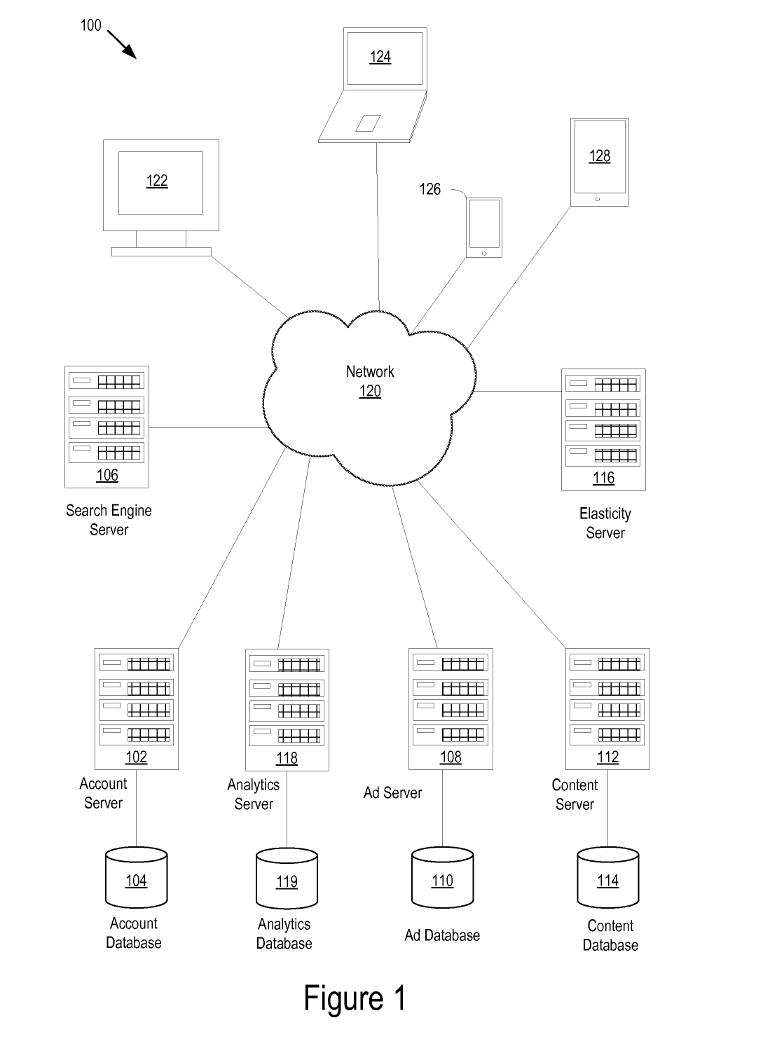

FIG. 1 illustrates a block diagram of an example information system that includes example devices of a network that can communicatively couple with an example system that provides ad quality scores and scores defining the effect of an ad's quality on an online host property (such as elasticity scores). The information system 100 in the example of FIG. 1 includes an account server 102, an account database 104, a search engine server 106, an ad server 108, an ad database 110, a content database 114, a content server 112, an elasticity server 116, an analytics server 118, and an analytics database 119. The aforementioned servers and databases can be communicatively coupled over a network 120. The network 120 may be a computer network. The aforementioned servers may each be one or more server computers.

The information system 100 may be accessible over the network 120 by advertiser devices and audience devices, which may be desktop computers (such as device 122), laptop computers (such as device 124), smartphones (such as device 126), and tablet computers (such as device 128). An audience device can be a user device that presents online advertisements, such as a device that presents online advertisements to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on online properties, such as web pages, and other communications sent over the network to audience devices. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. A sketch can be a category represented by a data structure or a complex value, such as a hash. A sketch can include limits, and co-limits. A model of the sketch in a category C can be a functor M : D→C, which takes each specified cone to a limit cone in C and each specified co-cone to a co-limit co-cone in C. See http://en.wikipedia.org/wiki/Sketch_(mathematics).

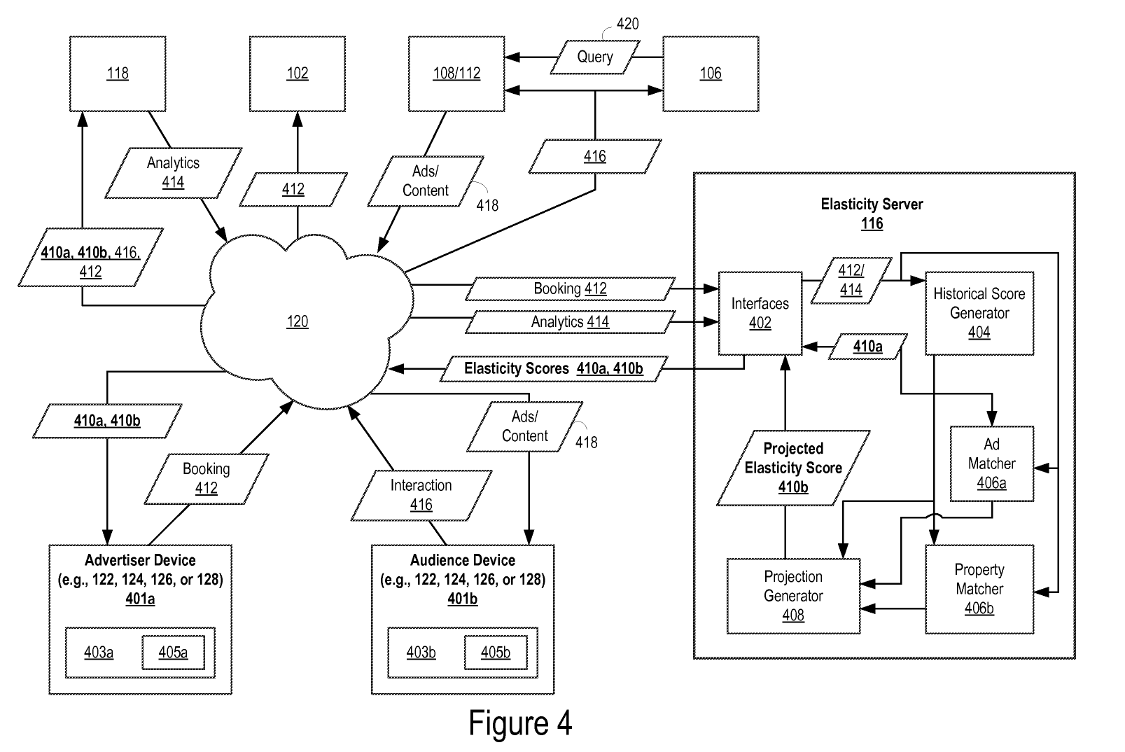

The account information may include ad booking information (such as ad booking data 412 of FIG. 4), and such booking information may be communicated to the elasticity server 116 for processing. This booking information can be used as input for determining historical elasticity scores, projected elasticity scores, or both (See historical elasticity score data 410a and projected elasticity score data 410b in FIG. 4). Also, elasticity scores can be fed back to the account server 102 or a user interface of the account server (such as client-side application 403a of FIG. 4), and influence the booking of ads. Furthermore, although throughout this disclosure determinations and uses of elasticity scores are exemplified, such determinations may be replaced with other types of score determinations associated with effects of advertising on user engagement with host properties.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser (such as the client-side application 403a). The advertiser front end may be a program, application, or software routine that forms a user interface. In a particular example, the advertiser front end is accessible as a website with electronic properties that an accessing advertiser may view on an advertiser device, such as one of the devices 122-128 when logged on by an advertiser. The advertiser may view and edit account data and advertisement data, such as ad booking data, using the advertiser front end. After editing the advertising data, the account data may then be saved to the account database 104.

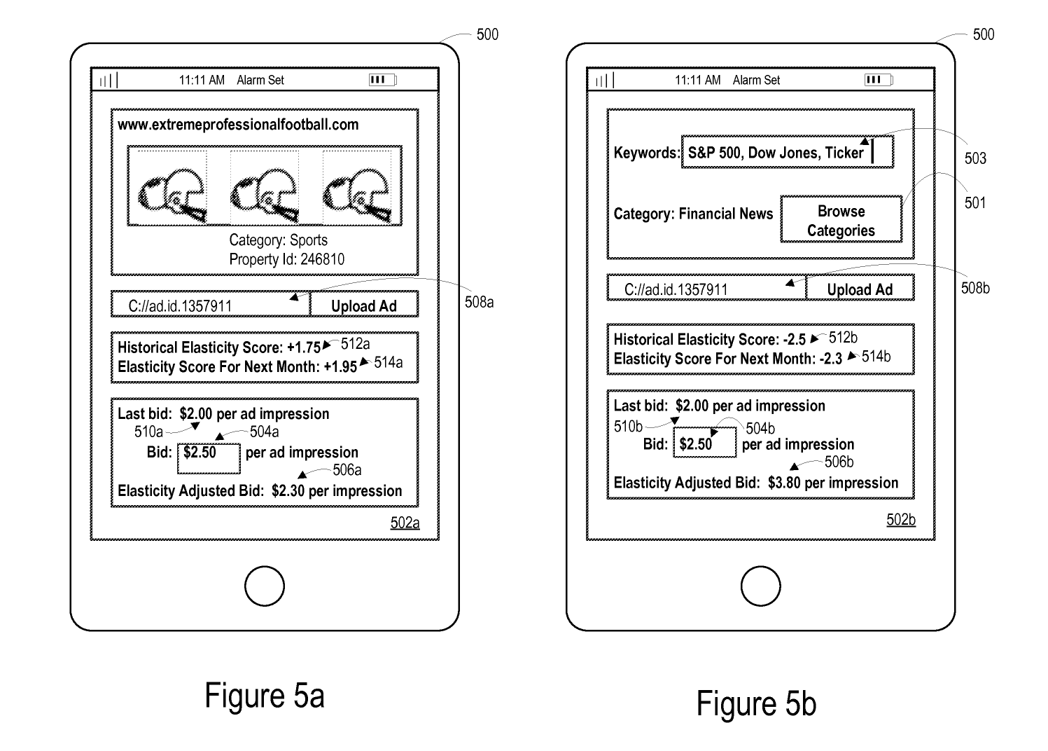

Also, historical elasticity scores, projected elasticity scores, historical ad quality scores, projected ad quality score, or any combination thereof may be viewed in real time using the advertiser front end. The advertiser front end may be a client-side application, such as the client-side application 403a running on the advertiser client device 401a. A script and/or applet (such as a script and/or applet 405a of FIG. 4) may be a part of this front end and may render access points for retrieval of the historical elasticity scores, projected elasticity scores, historical ad quality scores, projected ad quality score, or any combination thereof. In an example, this front end may include a graphical display of fields for placing bids on ad slots, and such bids may be shown as adjusted according to the historical elasticity scores, projected elasticity scores, historical ad quality scores, projected ad quality score, or any combination thereof (e.g., see FIGS. 5a and 5b). The front end, via the script and/or applet, can request the historical elasticity scores, projected elasticity scores, historical ad quality scores, projected ad quality score, or any combination thereof. The information can then be displayed, such as displayed according to the script and/or applet.

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices over the network 120. An audience client device may communicate a user query to the search engine server 106, such as via the interaction data 416. For example, a query entered into a query entry box can be communicated to the search engine server 106. The search engine server 106 locates matching information using a suitable protocol or algorithm and returns information to the audience client device, such as in the form of ads or content. As depicted in FIG. 4, the search engine server 106 may receive the interaction data 416 from an audience device, send a corresponding query 420 to the ad server 108 and/or the content server 112, and the ad server 108 and/or the content server 112 may serve corresponding ads and/or content 418. The information inputted and/or outputted by these devices may be logged in data logs and communicated to the analytics server 118 for processing, via the network 120.

The search engine server 106 may be designed to help users and potential audience members find information located on the Internet or an intranet. In an example, the search engine server 106 may also provide to the audience client device over the network 120 an electronic property, such as a web page, with content, including search results, information matching the context of a user inquiry, links to other network destinations, or information and files of information of interest to a user operating the audience client device, as well as a stream or web page of content items and advertisement items selected for display to the user. This information provided by the search engine server 106 may also be logged, and such logs may be communicated to the analytics server 118 for processing. Once processed into corresponding analytics data (such as the analytics data 414), such data can be input for determining elasticity scores (such as elasticity scores data 410a and 410b) or other types of scores associated with effects of advertising on user engagement with host properties. The analytics data 414 may include ad quality scores and analytics associated with user interactions on online properties associated with the ad quality scores.

The search engine server 106 may enable a device, such as an advertiser client device or an audience client device, to search for files of interest using a search query. Typically, the search engine server 106 may be accessed by a client device (such as the devices 122-128) via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 operates to serve advertisements to audience devices. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120. The aforementioned audience targeting information and the other data associated an ad may be logged in data logs and such logs may be communicated to the analytics server 118 for processing. Once processed into corresponding analytics data, such data can be input for determining elasticity scores.

For online service providers, advertisements may be displayed on electronic properties resulting from a user-defined search based, at least in part, upon search terms. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data, such data can be input for determining elasticity scores.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data, such data can be input for determining elasticity scores.

Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data, such data can be input for determining elasticity scores.

Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data (which may include user interaction data such as the interaction data 416) may be logged in data logs and such logs may be communicated to the analytics server 118 for processing. Once processed into corresponding analytics data, such data can be input for determining elasticity scores.

The ad server 108 includes logic and data operative to format the advertisement data for communication to an audience member device, which may be any of the devices 122-128. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data, such data can be input for determining elasticity scores.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs and such logs may be communicated to the analytics server 118 for processing. Once processed into corresponding analytics data, such data can be input for determining elasticity scores.

Further, the ad server 108 is in data communication with the network 120. The ad server 108 communicates ad data and other information to devices over the network 120. This information may include advertisement data communicated to an audience device. This information may also include advertisement data and other information communicated with an advertiser device. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the elasticity server 116, the analytics server 118, and/or the account server 102, for classification and quality scoring of the ad items (such as associating the ad items with audience segments, segment combinations, or at least parts of campaigns, and quality scoring the ad items according to metrics obtained from user session logs and to an amount in which the ad items match their respective audience segment, segment combinations, or at least parts of campaigns). This information can be input for the determining elasticity scores such as elasticity scores data 410a and 410b.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device. In viewing and editing the advertising data, adjustments to quality scores and elasticity scores may be determined and presented upon editing of the advertising data, so that a publisher can view how changes affect elasticity scores.

The ad server 108 may be one or more servers. Alternatively, the ad server 108 may be a computer program, instructions, and/or software code stored on a computer-readable storage medium that runs on one or more processors of one or more servers. The content server 112 may access information about content items either from the content database 114 or from another location accessible over the network 120. The content server 112 communicates data defining content items and other information to devices over the network 120.

The information about content items may also include content data and other information communicated by a content provider operating a content provider device, such as respective audience segment information. A content provider operating a content provider device may access the content server 112 over the network 120 to access information, including the respective segment information. This access may be for developing content items, editing content items, deleting content items, setting and adjusting bid amounts and other activities, such as associating content items with audience segments, segment combinations, or at least parts of campaigns. A content provider operating a content provider device may also access the elasticity server 116 over the network 120 to access analytics data and/or elasticity scores. Such analytics and elasticity scores may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120. In editing the content data, adjustments to quality scores and elasticity scores may be determined and presented upon editing of the content data, so that a publisher can view how changes affect elasticity scores.

The content provider front end may be a client-side application, such as a client-side application 403a or 403b running on the advertiser client device 401a or the audience client device 401b, respectively. A script and/or applet, such as the script and/or applet 405a or 405b, may be a part of this front end and may render access points for retrieval of elasticity scores, and the script and/or applet may manage the retrieval of the elasticity scores. In an example, this front end may include a graphical display of fields for selecting audience segments, segment combinations, or at least parts of campaigns. Then this front end, via the script and/or applet, can request elasticity scores for the audience segments, segment combinations, or at least parts of campaigns. The scores can then be displayed, such as displayed according to the script and/or applet.

The content server 112 includes logic and data operative to format content data for communication to the audience device. The content server 112 can provide content items or links to such items to the analytics server 118 or the elasticity server 116 to associate with elasticity scores and ad quality scores. For example, content items and links may be matched to such data. The matching may be complex and may be based on historical information related to the audience segments and such scores. Techniques for matching content items and links to the elasticity and the ad quality scores are numerous.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data may be logged in data logs and such logs may be communicated to the analytics server 118 for processing. Once processed into corresponding analytics data, such data can be input for determining elasticity scores.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data, such data can be input for determining elasticity scores.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

An advertiser client device, which may be any one of the device 122-128, includes a data processing device that may access the information system 100 over the network 120. The advertiser client device is operative to interact over the network 120 with any of the servers or databases described herein. The advertiser client device may implement a client-side application for viewing electronic properties and submitting user requests. The advertiser client device may communicate data to the information system 100, including data defining electronic properties and other information. The advertiser client device may receive communications from the information system 100, including data defining electronic properties and advertising creatives. The aforementioned interactions and information may be logged in data logs and such logs may be communicated to the analytics server 118 for processing. Once processed into corresponding analytics data, such data can be input for determining elasticity scores.

In an example, content providers may access the information system 100 with content provider devices that are generally analogous to the advertiser devices in structure and function. The content provider devices provide access to content data in the content database 114, for example.

An audience client device, which may be any of the devices 122-128, includes a data processing device that may access the information system 100 over the network 120. The audience client device is operative to interact over the network 120 with the search engine server 106, the ad server 108, the content server 112, the elasticity server 116, and the analytics server 118. The audience client device may implement a client-side application for viewing electronic content and submitting user requests. A user operating the audience client device may enter a search request and communicate the search request to the information system 100. The search request is processed by the search engine and search results are returned to the audience client device. The aforementioned interactions and information may be logged in data logs and such logs may be communicated to the analytics server 118 for processing. Once processed into corresponding analytics data, such data can be input for determining elasticity scores.

In other examples, a user of the audience client device may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device. The aforementioned interactions and information may be logged in data logs and such logs may be communicated to the analytics server 118 for processing. Once processed into corresponding analytics data, such data can be input for determining elasticity scores.

An advertiser client device and an audience client device operate as a client device when accessing information on the information system 100. A client device, such as any of the devices 122-128, may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs and such logs may be communicated to the analytics server 118 for processing. Once processed into corresponding analytics data, such data can be input for determining elasticity scores.

Also, the disclosed methods and systems may be implemented at least partially in a cloud-computing environment, at least partially in a server, at least partially in a client device, or in a combination thereof.

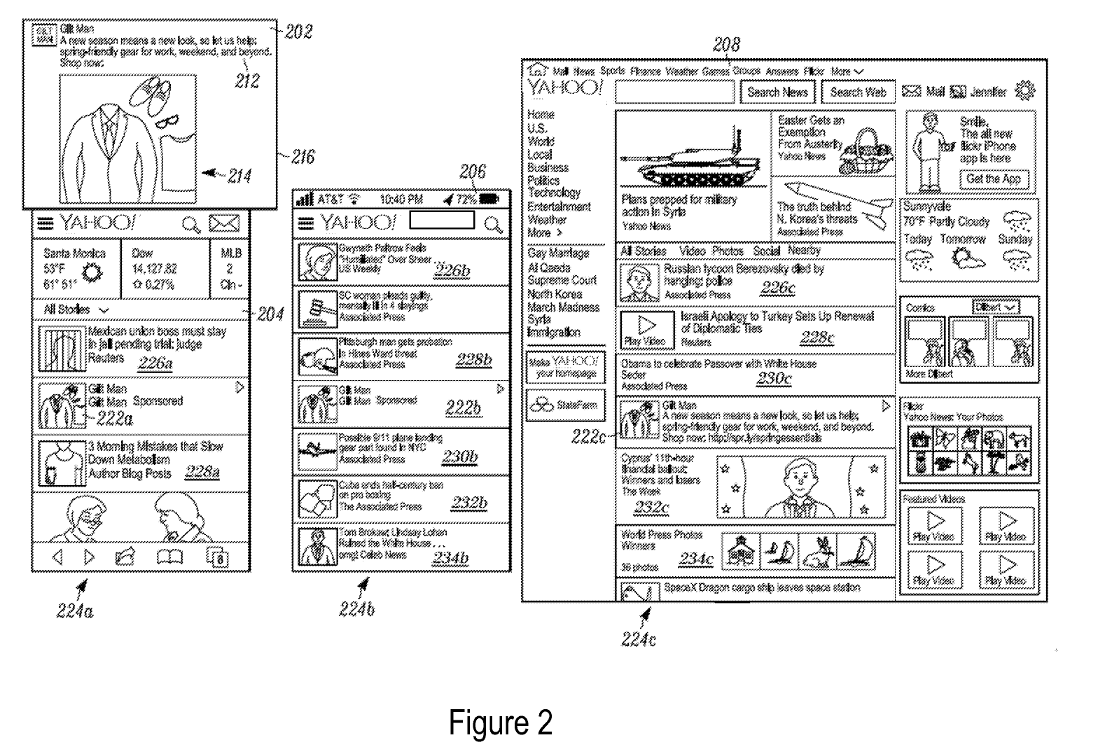

FIG. 2 illustrates displayed ad items and content items of example screens rendered by client-side applications. The content items and ad items displayed may be provided by the search engine server 106, the ad server 108, or the content server 112. User interactions with the ad items and content items can be tracked and logged in data logs (such as the interaction data 416), and the logs may be communicated to the analytics server 118 for processing. Once processed into corresponding analytics data, such data can be input for determining elasticity scores. Furthermore, as mentioned, although throughout the disclosure determinations of elasticity scores are exemplified, such determinations may be replaced with other types of score determinations associated with effects of advertising on user engagement with host properties.

In FIG. 2, a display ad 202 is illustrated as displayed on a variety of displays including a mobile web device display 204, a mobile application display 206 and a personal computer display 208. The mobile web device display 204 may be shown on the display screen of a smart phone, such as the device 126. The mobile application display 206 may be shown on the display screen of a tablet computer, such as the device 128. The personal computer display 208 may be displayed on the display screen of a personal computer (PC), such as the desktop computer 122 or the laptop computer 124.

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the analytics server 118 for processing. Once processed into corresponding analytics data, such data can be input for determining elasticity scores.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a,224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view. Such interactions may be communicated to the analytics server 118; and once processed by the analytics server into corresponding analytics data, such data can be input for determining elasticity scores.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs (such as the interaction data 416), and such logs may be communicated to the analytics server 118 for processing. Once processed by the analytics server into corresponding analytics data, such data can be input for determining elasticity scores.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs (such as the interaction data 416), and such logs may be communicated to the analytics server 118 for processing. Once processed by the analytics server into corresponding analytics data, such data can be input for determining elasticity scores.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms. Also, slotting may be according to corresponding ad quality scores and elasticity scores.

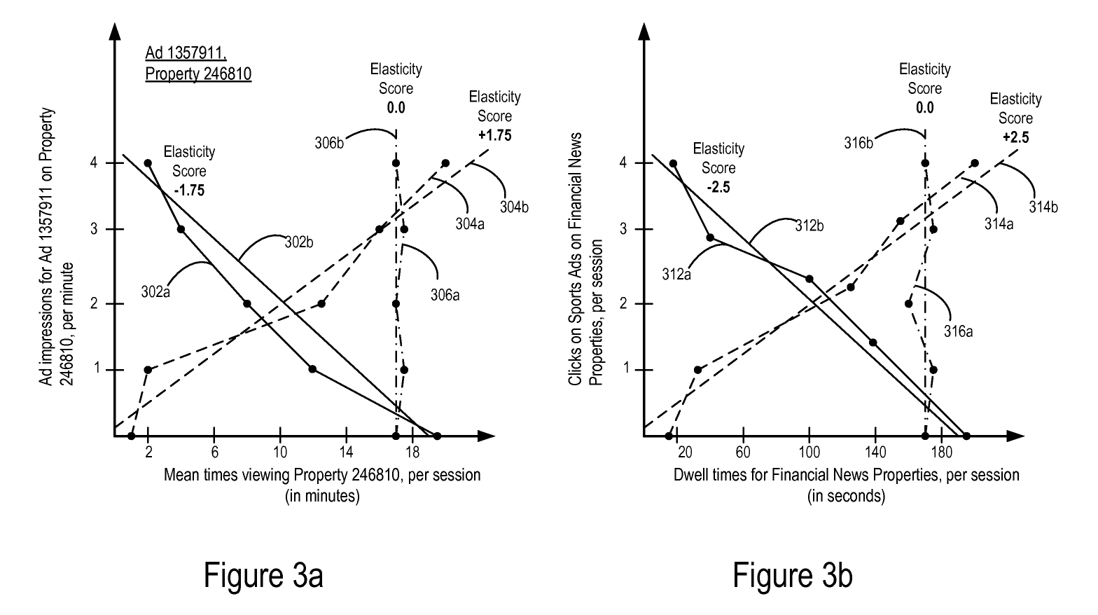

FIGS. 3a and 3b illustrate example alternative sets of graphed data points representative of elasticity scores. The respective graphed functions of these sets of points are graphed functions 302a, 304a, 306a, 312a, 314a, and 316a. The elasticity scores labeled in these figures are positive and negative decimal numbers related to corresponding slopes 302b,304b, 306b, 312b, 314b, and 316b of the respective graphed functions 302a, 304a, 306a, 312a, 314a, and 316a. Positive decimal numbers (such as the scores associated with the slopes 302b and 312b) signify that the ad and/or the ad type has a positive effect on engagement with the property and/or the property type. Conversely, negative decimal numbers (such as the scores associated with the slopes 304b and 314b) signify that the ad and/or the ad type has a negative effect on engagement with the property and/or the property type. Slopes 306b and 316b, associated with scores of zero, signify that the ad and/or ad type has no measurable effect on the property and/or property type. In FIGS. 3a and 3b, the labeled elasticity scores are historical elasticity scores for purposes of illustration with FIGS. 5a and 5b, but these scores just as well could be projected elasticity scores. In FIGS. 5a and 5b, historical elasticity scores 512a and 512b are related to the slopes 304b and 312b, respectively. The slopes in FIGS. 3a and 3b are results of linear regressions (such as simple linear regressions) of their respective graphed functions. In other words, each slope may be a straight line through its respective set of points, in which the line is graphed in a way that makes a sum of vertical distances between the points and the line as small as possible. In an example, an elasticity score may be the result of any type of linear regression (such as a simple linear regression) or a derivative of the result of the linear regression of a set of data points defining an effect of an ad on an online property (such as elasticity of engagement to ad quality). For example, a derivative of the result of the linear regression may be a score that is weighted. Also, although FIG. 3a depicts a graph for an ad and property pair and FIG. 3b depicts a graph for an ad type and content type pair, the system may apply the aforementioned functionality to particular ad and content type pairs and ad type and particular property pairs.

FIG. 4 illustrates a block diagram of the example information system of FIG. 1 (information system 100) interacting with example systems that can provide ad quality scores and scores defining the effects of ad quality on online host properties (such as elasticity scores). For example, FIG. 4 illustrates the elasticity server 116, which can provide the aforementioned scores including elasticity scores. Also, the analytics server 118 can provide ad quality scores and scores defining the effects of ad quality on host properties.

As mentioned, ad quality can be defined by a score. Such a score can be determined according to a measurement of ad quality, such as click through rate (CTR). Ad quality measurements can then be plotted against their effect on user engagement with host properties. Such a plot or set of data points can be defined by a linear regression or another type of calculation that can summarize the data points into a score. This score can represent how user engagement with an online property is effected by the ad quality provided on that property. For example, a score can define an elasticity of user engagement with a property to ad quality. Using such an elasticity score (or another type of score that defines the effect of ad quality on a host property), the system can determine the effect of subsequent ads of similar quality displayed on similar properties. Also, using such scores, content and ad network providers can adjust ad booking pricing to be more commensurate with an ad's effect on host properties.

In an example, the system can use an ad quality index to evaluate the quality of an ad with respect to an online property. Such an index can be generated using a score representative of an effect of ad quality on user engagement with an online property (e.g., an elasticity score). In examples, the index can provide the appropriateness of a given ad for specific content. For each ad and property pair in the index, the system can determine the effect on audience engagement with the property due to the paired ad. Also, the index can be used to determine a cost measure for the ad and property pair that can be used to control the booking and delivery of the ad on the property. For example, the index can be used to determine whether a given piece of content will host a certain ad or not. Also, whether or not an advertiser will have to pay a corresponding penalty due to its ad having a negative effect on the user engagement with the property. Conversely, it may be determined whether the advertiser receives a corresponding discount due to its ad having a positive effect on the engagement with the property.

In an example, the system can use CTR associated with the ad as a measure of ad quality. CTR is useful because it has been found that a higher CTR can imply a higher quality ad in general or at least with respective to its host content. However, CTR may be a function of the placement of the ad. Because of such limitations, other properties may be used that also imply ad quality, and such other properties may compliment CTR to achieve a more complete picture of ad quality. Other properties that may be used to evaluate ad quality may include the quality of the content that hosts the ad, time spent displaying the ad, dwell times associated with the ad, and many other ad properties. Also, ad quality can be modeled by its creative quality and viewability. Viewability can be a product of an ad's impression frequency at varying positions within page views.

In yet another example, the system may determine a totality of features of an ad. Such a totality of features can be determined through machine learning, a manual editorial process, or both. In such an example, the determination may be binary in that the ad either receives a negative or positive quality score. Also, in an example, the system can use ad quality technologies such as Demand Quality Management (DQM), Supply Quality Management (SQM), or both. DQM can set tags on a creative and determine features of a creative, in which it tags. SQM can provide similar functionality but from the perspective of the supply side oppose to the demanding party.

Aspects that are part of a system for generating and providing ad quality scores and elasticity scores can be hosted in the elasticity server 116. However, it may be advantageous to provide the aforementioned ad quality determinations at another server, such as an analytics server 118, to reduce the processing burden on the elasticity server 116. In the illustrated example of the system in FIG. 4, the analytics server 118 provides analytics data 414 to the elasticity server 116. As mentioned, analytics data (such as the analytics data 414) can include results of ad quality determinations, and the analytics data can be used as input for the determination of scores defining the effects of ads on user engagement with properties (such as elasticity scores).

Also, any of the depicted aspects of the system, for generating and providing ad quality scores and elasticity scores, may be hosted on a device external to the elasticity server 116. For example, the advertiser client device 401a and the audience client device 401b (each which may be any of the client devices 122-128) can host respective client-side applications 403a and 403b that can host or at least be associated with the respective scripts and/or applets 405a and 405b that can manage the selection, retrieval, and/or presentation of ad quality scores and elasticity scores. Depending on the implementation, such scores can be presented in real time or with a noticeable processing delay. In an example, the presentation can be rendered through the respective client-side applications 403a and 403b.

In an example, the parts of the elasticity server 116 that can provide the scores to other devices are the interfaces 402. The interfaces 402 can include communication interfaces, such as network ports and transceivers that include data formatting circuits. The data formatting circuits can format incoming and outgoing data to be compliant with various communication and data transfer protocols. The interfaces 402 may be communicatively coupled with any of the devices depicted in FIG. 1 through the network 120. As depicted in FIGS. 1 and 4, the network 120 communicatively couples the elasticity server 116 with the other servers of FIGS. 1 and 4, and their respective databases. Any of these databases, depicted in FIG. 1 can store ad quality scores, elasticity scores, or both. Also, caches associated with any of the servers depicted in FIG. 1 can store ad quality scores, elasticity scores, or both, so that such scores can be readily accessible and be provided in real time.

In addition to the interfaces 402, FIG. 4 depicts the elasticity server 116 hosting a historical score generator 404, an ad matcher 406a, a property matcher 406b, and a projection generator 408. The interfaces 402 may be communicatively coupled to the historical score generator 404, the ad matcher 406a, the property matcher 406b, the projection generator 408, or any combination thereof. The ad matcher 406a and the property matcher 406b may be communicatively coupled to the historical score generator 404, the projection generator 408, or both. Also, the historical score generator 404 may be communicatively coupled to the projection generator 408. These aforementioned communicative couplings provide channels for transferring data amongst parts of the information system 100. Each of the aforementioned parts of the elasticity server 116 may be or include circuitry.

Besides the channels between parts of the system 100, FIG. 4 also depicts data flow between the parts. For example, the elasticity server 116 can communicate historical elasticity score data 410a and projected elasticity score data 410b to other devices of FIGS. 1 and 4, such as the advertiser client device 401a. The elasticity scores data 410a and 410b can be a result a user requesting such data from a user interface of the advertiser client device 401a. A request from the advertiser client device 401a can include ad booking data 412. The advertiser client device 401a can communicate ad booking data 412 to other devices of FIGS. 1 and 4, such as the account server 102 and the elasticity server 116. Not depicted in FIG. 4, the advertiser client device 401a can also communicate ad booking data 412 to the ad server 108. The ad booking data 412 can be input for the determination of the historical elasticity score data 410a and the projected elasticity score data 410b.

Ad booking data 412 can include information associated with the delivery of one or more online ads. Ad booking data 412 can include targeting data, such as selected audience segments, audience segment combinations, and at least parts of ad campaigns to be associated with the ad(s) for targeting the ad(s). For example, certain ad impressions can be associated with audience members sharing one or more demographics, psychographics, interests, or preferences (such as preferences for medium and devices to receive ads or content). Ad booking data 412 can include budget information, such as price cap per ad, a price cap per ad impression, price cap per ad click, price cap per targeted audience segment or combination of segments, a price cap per ad campaign, a daily, weekly, monthly, and/or yearly price cap, total funds in an advertiser's account, and the like. Booking data can include timing information, such as ad impression timing information. The timing information can include dayparting information. Ad impression timing information can include restrictions or preferences on times of the day, week, month, or year that ad impressions may be delivered. Ad booking data 412 can include ad formatting data, such as size, shape, pixilation, hertz, positioning, color scheme, file type, and data type of ads or ads per impression. Ad booking data 412 can also include strategies or routines that combine any one or more aspects of targeting data, budget information, timing information, and ad formatting data.

The analytics server 118 can communicate analytics data 414 to devices of FIGS. 1 and 4, such as the elasticity server 116. The analytics data 414 can be determined at the analytics server and stored, for retrieval, in the analytics database 119. The analytics data can include ad quality data. The analytics data 414, including the ad quality data, can be derived from interaction data 416 and/or booking data 412 at the analytics server 118. The analytics data 414 can be input for the determination of the the historical elasticity score data 410a and the projected elasticity score data 410b. The analytics data 414 can include ad engagement data that may include data regarding ad impressions, ad display time, ad placement within or proximate to the property, ad size (such as size relative to the property), ad click amounts, other measurable parameters relevant to user engagement with the ad and/or presentation of the ad, or any combination thereof. Such engagement data can be input for ad quality determinations. The analytics data 414 can also include property engagement data that may include data regarding property impressions, property display time, dwell times, property arrangement relative to the ad, property size (such as size relative to the ad), property click amounts, and other measurable parameters relevant to user engagement with the property and/or presentation of the property, or any combination thereof. The booking data 412 may also include ad engagement data and property engagement data.

Analytics data 414 can also include ad impressions delivered. For example, the analytics data 414 can include a historical ad impressions delivery rate for an audience segment, a combination of segments, or at least a part of an ad campaign. Also, the analytics data 414 can include a historical amount of ad impressions delivered for a segment, a combination of segments, or at least a part of an ad campaign. Analytics data 414 can also include estimated analytics for future delivery of ad impressions for a segment, a combination of segments, or at least a part of an ad campaign. Analytics data 414 can also include historical and estimated future analytics on delivery of content for a segment, a combination of segments, or at least a part of an ad campaign. Analytics data 414 can also include historical and estimated future analytics on various types of ad booking data or various types of data related to the development, production, and delivery of ads or content, such as content including or associated with ads. Analytics data 414 can also include forecasted bids and forecasted pricing information. Analytics data can also include correlation data, such as data representing correlations between segments. Analytics data 414 can also include analytics on user interactions with content and ads online, such as analytics on click-through rate (CTR) per content item or ad item, per audience segment, segment combination, or at least part of an ad campaign.

The interaction data 416 can be identified and communicated from the audience client device 401b to the analytics server 118. Also, the interaction data 416, such as data including search engine inputs can be communicated from the audience client device 401b to the search engine server 106, and the search engine server, as a result of receiving the search engine inputs can generate and communicate a corresponding search query 420 for retrieval of ads and content from the ad server 108 and the content server 112. Also, the interaction data 416, such as data including URLs within hyperlinks can be communicated from the audience client device 401b to the ad server 108 and/or the content server 112, for getting corresponding ads and/or content 418. Although not depicted in FIG. 4, interaction data 416 can be identified and communicated from any of the devices of FIGS. 1 and 4. Additionally, ads and/or content 418 can be communicated to any of the devices of FIGS. 1 and 4 from any of the devices of FIGS. 1 and 4, such as servers 102, 106, 108, and 112.

Interaction data 416 can include CTR focused at varying levels of abstraction, including CTR per content item or ad item, per audience segment, segment combination, or at least part of an ad campaign. Interaction data 416 can include ad impression delivery rate focused at varying levels of abstraction, including ad impression delivery rate per ad, per audience segment, segment combination, or at least part of an ad campaign. Interaction data 416 can include dwell times, booked marked content, selected preferences, different refresh rates, such as page refresh rates. Interaction data 416 can include information on any type of web browsing behavior or estimated intent of a user. Interaction data 416 can include data representative of clicks, likes, page views, filling out forms or individual fields, and selections of streaming content, downloads, or uploads.

As depicted in FIG. 4, the ad booking data 412 and the analytics data 414 are received by the interfaces 402. The interfaces 402 can then further process the ad booking data 412 and the analytics data 414 for using such data as input for historical elasticity score determinations at the historical score generator 404. The historical score generator 404, from these inputs can derive historical elasticity score per audience segment and/or combination of audience segments, such as a combination of determined related segments, or per at least part of an ad campaign. The historical score generator 404, from these inputs can derive a historical elasticity score per any measurable parameters relevant to user engagement with an ad and/or presentation of an ad, or any combination thereof, and per any measurable parameters relevant to user engagement with an online property and/or presentation of a property, or any combination thereof.

The historical elasticity score data 410a, which includes the determined one or more historical elasticity scores, can be further manipulated by various factors that can result in the projected elasticity score data 410b, which can include one or more projected elasticity scores. The various factors can include ad matching and property matching, and determinations of such factors can occur at the ad matcher 406a and the property matcher 406b, respectively. The ad matcher 406a can be configured to match a first ad with a second ad, a first ad type with a second ad type, or any combination thereof, such as matching a first ad with a first ad type or a second ad type. Ad matching can be according to one or more features within a first ad and a second ad that match.

The property matcher 406b can be configured to match a first property with a second property, a first property type with a second property type, or any combination thereof, such as matching a first property with a first property type or a second property type. Property matching can be according to one or more features within a first property and a second property that match.

The one or more features for matching the ads and/or the properties may be selectable, via a user interface, such as by an advertiser, an online property provider, a network provider, or any combination thereof. The one or more features may also be determined by machine learning according to data trends with respect to a general marketplace or the specific marketplace for the ad and property pair. The the one or more features for matching the ads and/or the properties may pertain to subject matter, formatting, content quality, or any combination thereof.

The projected elasticity score data 410b and the historical elasticity score data 410a can be communicated from the interfaces 402 to the other devices of the information system 100, such as the advertiser client device 401a. The advertiser client device 401a, can further process such data and render historical and/or projected elasticity scores for an ad and property pair. Such processing and rendering can provide an advertiser historical and/or projected elasticity scores per selected audience segment, segment combination, or at least part of an ad campaign. Such processing and rendering can also provide historical and/or projected elasticity scores per any measurable parameters relevant to user engagement with an ad and/or presentation of an ad, or any combination thereof, and per any measurable parameters relevant to user engagement with an online property and/or presentation of a property, or any combination thereof.

The historical score generator 404 can determine a historical elasticity score per ad and property pair. Besides determining elasticity scores (whether historical or projected) per specific ad and property pair, the system can determine elasticity scores per ad type and content type pair, ad type and particular property pair, particular ad and content type pair, or any combination thereof.

The historical elasticity score can be determined based on the ad booking data 412 and the analytics data 414. Also, the historical score generator 404 can determine the historical elasticity score per any measurable parameters relevant to user engagement with an ad and/or presentation of an ad, or any combination thereof.

In an example, the historical score generator 404 can be configured to determine a historical score representative of a historical effect of a first ad on a first online property. Such a score may be or at least include a historical elasticity score. The determination of the historical score can be based on engagement data associated with the first ad and relevant to the first online property (e.g., while the first ad is within the first online property), property engagement data associated with the first online property and relevant to the first ad, or both. This input data may be included in the ad booking data 412, the analytics data 414, or both.

The ad engagement data and/or the property engagement data may be identifiable within user session logs (e.g., user session logs that log engagement with ads and properties). For example, the interaction data 416 and/or the ad booking data 412 may include these session logs. The ad engagement data may include data regarding ad impressions, ad display time, ad placement within or proximate to the property, ad size (such as size relative to the property), ad click amounts, other measurable parameters relevant to user engagement with the ad and/or presentation of the ad, or any combination thereof. The property engagement data may include data regarding property impressions, property display time, dwell times, property arrangement relative to the ad, property size (such as size relative to the ad), property click amounts, and other measurable parameters relevant to user engagement with the property and/or presentation of the property, or any combination thereof.

The historical score may be or may be representative of a set of data points (such as the alternative data points depicted in FIGS. 3a and 3b). Each data point of a set of data points may illustrate ad engagement quantities of a measurable ad parameter (such as an average amount of ad time per user session) versus property engagement quantities of a measurable property parameter (such as an average amount of property display time per user session). The ad engagement quantities can include averages or total quantities for a group of users. The property engagement quantities can include averages or total quantities for the group of users. Average quantities can include mean quantities, median quantities, or mode quantities. A group of users may be all tracked users or may be a selective or arbitrary sampling of one or more of the tracked users. Selective sampling may be according to a demographic, a psychographic, or any combination thereof. In other words, a group of users may be grouped according to a demographic, a psychographic, or any combination thereof.

Besides determining historical scores and projected scores per pair and per any measurable parameters relevant to user engagement with an ad and/or with an online property and/or presentation of an ad and/or a property, such determinations of scores may be per group of users as well. For example, the historical score generator 404 can determine the historical elasticity score per audience segment, segment combination, or at least part of a campaign. In such an example, the ad booking data 412 can provide a selected audience segment, segment combination, or at least part of a campaign, and the analytics data 414 can provide filtered impression logs including impressions associated with the selected audience segment, segment combination, or at least part of a campaign. The audience segment, segment combination, or at least part of a campaign is based on the ad booking data 412. The determination of the historical elasticity score can be based on the analytics data 414 relevant to the audience segment, segment combination, or at least part of a campaign.

The determined historical elasticity score alone or along with other inputs can be used for determining a projected elasticity score. The projection generator 408 can determine a projected elasticity score per ad and property pair, ad type and content type pair, an ad type and particular property pair, a particular ad and content type pair, or any combination thereof, according to at least a corresponding historical elasticity score. Also, the projection generator 408 can determine the projected elasticity score per audience segment, segment combination, or at least part of a campaign. Also, the projection generator 408 can determine the projected elasticity score per any measurable parameters relevant to user engagement with an ad and/or presentation of an ad, or any combination thereof; and per any measurable parameters relevant to user engagement with an online property and/or presentation of a property, or any combination thereof.

The projection generator 408 can also project a score that is the same as the corresponding historical score. The projected score can also be a product of the corresponding historical score and a weight. Also, the historical score can be reduced to historical sub-scores for different features and/or measurable quantities of the ad and/or property, and these sub-scores can be individually weighted in the determination of the historical score. Similarly, the projected score can be reduced to projected sub-scores for different features and/or measureable quantities of the ad and/or the property, and these sub-scores can be individually weighted in the determination of the projected score. In either case, the weights for each corresponding sub-score pair between the historical score and the projected score can have a same or different weight. The weights can be manually selected or determined by machine learning according to data trends with respect to a general marketplace or the specific marketplace for the ad and property pair. Besides determining weights according to data trends associated with the specific marketplace for the ad and property pair, weights can be determined for specific marketplaces for an ad type and content type pair, an ad type and particular property pair, a particular ad and content type pair, or any combination thereof.

Referring back to the interfaces 402, such circuitry may include output sub-circuitry configured to output one or more graphical user interface (GUI) elements representative of the projected score and/or the historical score. This sub-circuitry can also output the GUI element(s) within a GUI configured to accept bidding on ad impressions for the ad on the property. This sub-circuitry can also adjust a received bid for an ad impression according to the historical score and/or the projected score. The adjusted bid and the initially received bid can be outputted on the GUI proximate to each other (such as side by side to each other), so that an advertiser can see the effect of an ad on a host property (such as the effect of elasticity of engagement to ad quality) on the initial bid. This provides the advertiser with the opportunity to choose a different ad and/or host property. In an example, the sub-circuitry may be configured to output GUI elements representative of a projected elasticity score, a historical elasticity score, or both, within the GUI configured to accept a bid on an ad impression of an ad on the online property. The circuitry can then adjust a received bid on the ad impression according to the projected elasticity score, the historical elasticity score, or both, and output the adjusted bid along with the initially received bid. Besides particular ad and property pairs, the system can provide such functionality for ad type and content type pairs, ad type and particular property pairs, particular ad and content type pairs, or any combination thereof.

FIGS. 5a and 5b illustrate example GUIs displayed on an example client device 500 associated with an advertiser front end. The GUI 502a in FIG. 5a illustrates displaying of a received bid 504a for an ad impression associated with an ad with an ad ID “1357911” on a property titled “www.extremeprofessionalfootball.com” with a property ID “246810”. Also depicted, is an adjusted bid 506a, which is adjusted according to a historical score and/or a projected score pertaining to the effect of the ad quality on the property, such as a historical elasticity score and/or a projected elasticity score. In the GUI 502a, the bids are depicted within close proximity, so that the advertiser can readily see discrepancies and upload a new ad if the adjustment is undesirable. A new ad can be selected by via the “upload ad” GUI field 508a. In an example, an advertiser may upload a new ad and then the system can instantly (i.e., in real time) determine the new ad's ad quality and/or its impact on engagement with a given property and present an adjusted acceptable bid for displaying the ad on the property according to the determination. Also, the new ad's ad quality and/or impact on engagement can be displayed proximate to the adjusted bid.

Also, depicted is a last accepted bid amount for the ad impression 510a. The GUI 502a also displays the historical elasticity score 512a for the ad and property pair and the projected elasticity score 514a for the pair. The property titled “www.extremeprofessionalfootball.com” has been categorized by the system to be part of the sports group, so the elasticity scores may have been determined according to data regarding the specific ad and property pair, the specific ad and content type pair, or both. Although the ad type is not displayed in the GUI 502a, the ad type may also have been used in the determination of the elasticity scores 512a and 514a.

The GUI 502b in FIG. 5b illustrates displaying of received bid 504b for the ad impression associated with an ad with the ad ID “1357911” on properties categorized under a financial news category. The advertiser from this GUI can change the property category by selecting the button labeled “browse categories” 501 or by entering new keywords associated with a new category in the search field 503. Also depicted, is an adjusted bid 506b, which is adjusted according to a historical score and/or a projected score pertaining to the effect of the ad on a property in the category financial news, such as a corresponding historical elasticity score and/or a projected elasticity score. In the GUI 502b, the bids are depicted within close proximity, so that the advertiser can readily see discrepancies and upload a new ad if the adjustment is undesirable. A new ad can be selected by via the “upload ad” GUI field 508b. Also depicted is a last accepted bid amount for the ad impression 510b. The GUI 502b also displays the historical elasticity score 512b for the ad and content type pair and the projected elasticity score 514b for the pair. Since the advertiser in this example is bidding on an ad impression on any property of the system in the financial news category, the elasticity scores may have been determined according to data regarding the specific ad and content type pair. However, although the ad type is not displayed in the GUI 502b, the ad type may also have been used in the determination of the elasticity scores 512b and 514b.

In this example in FIG. 5b, the elasticity scores 512b and 514b are negative, so the adjusted bid per impression outputted is greater than the initial received bid. This is due to the ad having a negative effect on engagement with properties associated with the financial news category. This negative effect on properties in the category financial news category is shown by the graphed function 312a in FIG. 3b. The slope 312b of the graphed function 312a may be an input in the determination of the adjusted bid 506b. The opposite is the case in FIG. 5a. The elasticity scores 512a and 514a are positive, so the adjusted bid per impression outputted is less than the initial received bid. In the example in FIG. 5a, the ad has a positive effect on the property as shown by the graphed function 304a in FIG. 3a. The slope 304b of the graphed function 304a may be an input in the determination of the adjusted bid 506a.

In an example, adjusted bids (such as the adjusted bids 506a and 506b) may specify the minimum price that an advertiser has to pay for an impression of a certain ad on a certain property, an ad type on a certain property, a certain ad on a type of property, or any combination thereof. For example, an adjust bid may specify the minimum price that an advertiser has to pay for an impression of a certain ad on any property within a content network.

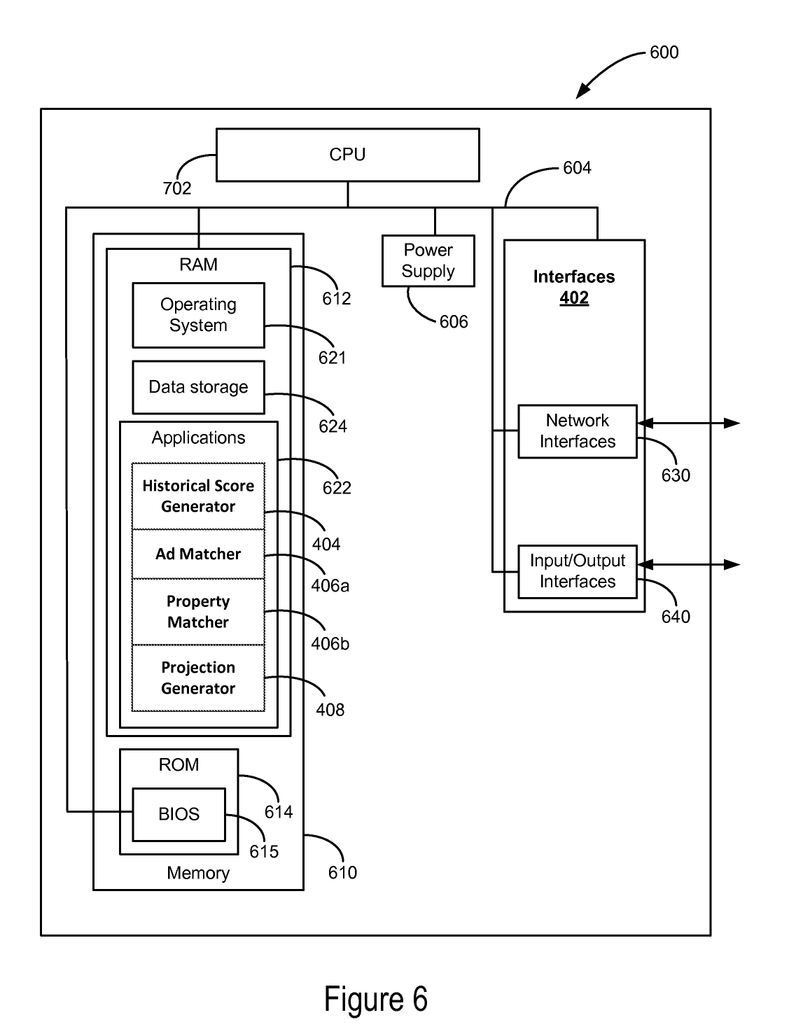

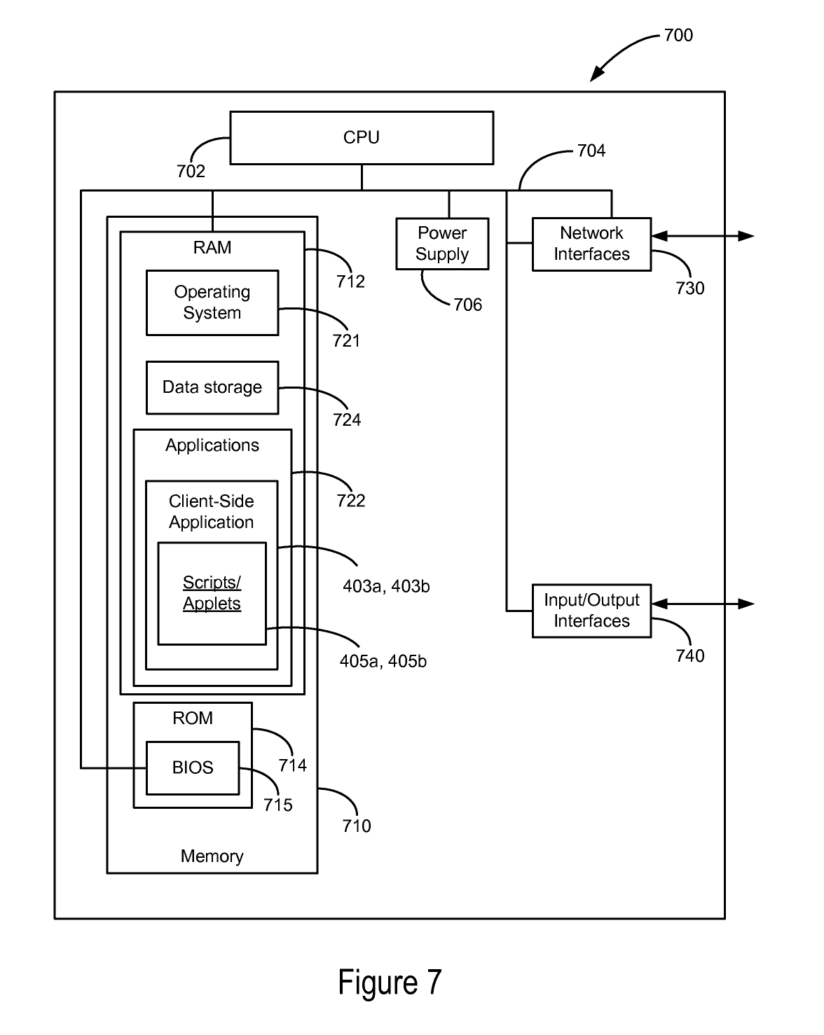

FIGS. 6 and 7 are block diagrams of example electronic devices that can implement aspects of and related to example systems that can provide effects of ad quality on user engagement with properties, such as through elasticity scores. FIG. 6 illustrates a server, such as the elasticity server 116. FIG. 7 illustrates a client device, such as any one of the client devices 122-128, 401a, and 401b.

FIG. 6 is a block diagram of an example of an electronic device 600 that can generate and/or share elasticity score data, such as elasticity score data 410a and 410b, and respond to requests for such data. The electronic device 600 can include a CPU 602, memory 610, a power supply 606, and input/output components, such as network interfaces 630 and input/output interfaces 640, and a communication bus 604 that connects the aforementioned elements of the electronic device. The network interfaces 630 can include a receiver and a transmitter (or a transceiver), and an antenna for wireless communications. The network interfaces 630 can also include at least part of the interfaces 402. The CPU 602 can be any type of data processing device, such as a central processing unit (CPU). Also, for example, the CPU 602 can be central processing logic.

The memory 610, which can include random access memory (RAM) 612 or read-only memory (ROM) 614, can be enabled by memory devices. The RAM 612 can store data and instructions defining an operating system 621, data storage 624, and applications 622, including the historical score generator 404, the ad matcher 406a, the property matcher 406b, and the projection calculator 408. The applications 622 may include hardware (such as circuitry and/or microprocessors), firmware, software, or any combination thereof. The ROM 614 can include basic input/output system (BIOS) 615 of the electronic device 600. The memory 610 may include a non-transitory medium executable by the CPU.

The power supply 606 contains power components, and facilitates supply and management of power to the electronic device 600. The input/output components can include at least part of the interfaces 402 for facilitating communication between any components of the electronic device 600, components of external devices (such as components of other devices of the information system 100), and end users. For example, such components can include a network card that is an integration of a receiver, a transmitter, and I/O interfaces, such as input/output interfaces 640. The I/O components, such as I/O interfaces 640, can include user interfaces such as monitors, keyboards, touchscreens, microphones, and speakers. Further, some of the I/O components, such as I/O interfaces 640, and the bus 604 can facilitate communication between components of the electronic device 600, and can ease processing performed by the CPU 602.

The electronic device 600 can send and receive signals, such as via a wired or wireless network, or may be capable of processing or storing signals, such as in memory as physical memory states, and may, therefore, operate as a server. The device 600 can include a single server, dedicated rack-mounted servers, desktop computers, laptop computers, set top boxes, integrated devices combining various features, such as two or more features of the foregoing devices, or the like.

FIG. 700 is a block diagram of an example of an electronic device 700 that can request elasticity score data (such as elasticity score data 410a and 410b), provide booking data (such as booking data 412), and provide interaction data (such as interaction data 416), such as the advertiser client device 401a or the audience client device 401b, respectively. The electronic device 700 can include a central processing unit (CPU) 702, memory 710, a power supply 706, and input/output components, such as network interfaces 730 and input/output interfaces 740, and a communication bus 704 that connects the aforementioned elements of the electronic device. The network interfaces 730 can include a receiver and a transmitter (or a transceiver), and an antenna for wireless communications. The CPU 702 can be any type of data processing device, such as a central processing unit (CPU). Also, for example, the CPU 702 can be central processing logic; central processing logic may include hardware (such as circuitry and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 710, which can include random access memory (RAM) 712 or read-only memory (ROM) 714, can be enabled by memory devices, such as a primary (directly accessible by the CPU) and/or a secondary (indirectly accessible by the CPU) storage device (such as flash memory, magnetic disk, optical disk). The memory 710 may include a non-transitory medium executable by the CPU.

The RAM 712 can store data and instructions defining an operating system 721, data storage 724, and applications 722, including the client-side application 403a or 403b and the script and/or applet 405a or 405b, respectively. The applications 722 may include hardware (such as circuitry and/or microprocessors), firmware, software, or any combination thereof. Example content provided by an application, such as the client-side application 403a or 403b, may include text, images, audio, video, or the like, which may be processed in the form of physical signals, such as electrical signals, for example, or may be stored in memory, as physical states, for example.

The ROM 714 can include basic input/output system (BIOS) 715 of the electronic device 700. The power supply 706 contains power components, and facilitates supply and management of power to the electronic device 700. The input/output components can include various types of interfaces for facilitating communication between components of the electronic device 700, components of external devices (such as components of other devices of the information system 100), and end users. For example, such components can include a network card that is an integration of a receiver, a transmitter, and I/O interfaces, such as input/output interfaces 740. A network card, for example, can facilitate wired or wireless communication with other devices of a network. In cases of wireless communication, an antenna can facilitate such communication. The I/O components, such as I/O interfaces 740, can include user interfaces such as monitors, keyboards, touchscreens, microphones, and speakers. Further, some of the I/O components, such as I/O interfaces 740, and the bus 704 can facilitate communication between components of the electronic device 700, and can ease processing performed by the CPU 702.

1. A system stored in a storage device executable by a processor, comprising:
historical score circuitry configured to determine a historical score representative of a historical effect of a first ad on a first online property, according to ad engagement data associated with the first ad and relevant to the first online property, property engagement data associated with the first online property and relevant to the first ad, or both;
matcher circuitry configured to match a second ad with the first ad, a second online property with the first online property, or both; and
projection circuitry configured to determine a projected score representative of a projected effect of the first ad on the first property, the first ad on the second property, the second ad on the first property, the second ad on the second property, or any combination thereof, according to a match by the matcher circuitry.

2. The system of claim 1, wherein the ad engagement data and the property engagement data include data associated with instances when the first ad is within the first online property.

3. The system of claim 1, wherein the historical score includes a historical elasticity score.

4. The system of claim 1, wherein the ad engagement data and the property engagement data is identifiable within user session logs.

5. The system of claim 1, wherein the ad engagement data includes data regarding ad impressions, ad display time, ad placement within or proximate to the property, ad size, ad click amounts, other measurable parameters relevant to user engagement with the ad, presentation of the ad, or both, or any combination thereof.

6. The system of claim 1, wherein the property engagement data includes data regarding property impressions, property display time, dwell times, property arrangement relative to the ad, property size, property click amounts, and other measurable parameters relevant to user engagement with the property, presentation of the property, or both, or any combination thereof.

7. The system of claim 1, wherein the historical score is or is representative of a set of data points.

8. The system of claim 7, wherein each data point of the set of data points illustrates ad engagement quantities of a measurable ad parameter versus property engagement quantities of a measure property parameter.

9. The system of claim 8, wherein the ad engagement quantities are averages or totals for a group of users.

10. The system of claim 9, wherein the property engagement quantities are averages or totals for the group of users.

11. The system of claim 10, wherein the averages are mean quantities, median quantities, or mode quantities.

12. The system of claim 9, wherein the group of users includes a selective sampling of one or more of tracked users.

13. The system of claim 9, wherein selective sampling is according to a demographic, a psychographic, or both.

14. A method, comprising:
determining, by server computer hardware, a historical elasticity score based on ad quality data associated with a first ad and relevant to a first online property, property engagement data associated with the first online property and relevant to the first ad, or both, wherein the historical elasticity score is representative of a historical effect of change associated with the first ad on change associated with the first property;
matching, by the server computer hardware, a second ad with the first ad, a second online property with the first online property, or both;
determining, by the server computer hardware, a projected elasticity score representative of a projected effect of change associated with the first ad on change associated with the first property, the change associated with the first ad on change associated with the second property, change associated with the second ad on the change associated with the first property, the change associated with the second ad on the change associated with the second property, or any combination thereof, according to the the matching of the second ad with the first ad, the second online property with the first online property, or both; and
communicating, by the server computer hardware, the historical elasticity score, the projected elasticity score, or both, over a computer network to client device hardware.

15. The method of claim 14, wherein the matching can be according to a feature within the first ad and the second ad that match, a feature within the first property and the second property that match, or both.

16. The method of claim 15, wherein the features are selectable through a user interface, determined by machine learning, or both.

17. The method of claim 15, wherein the features are relate to subject matter, formatting, content quality, or any combination thereof.

18. A server computer, comprising:
a central processing unit; and
a non-transitory storage medium including:
first circuitry executable by the central processing unit to determine a historical elasticity score based on ad quality data associated with a first ad and relevant to an online property, property engagement data associated with the online property and relevant to the first ad, or both, wherein the historical elasticity score is representative of a historical effect of change associated with the first ad on change associated with the property;
second circuitry executable by the central processing unit to match a second ad with the first ad according to at least a matching feature in the first ad and the second ad; and
third circuitry executable by the central processing unit to determine a projected elasticity score representative of a projected effect of change associated with the second ad on change associated with the property, according to the match between the first ad and the second ad.

19. The server computer of claim 18, wherein the non-transitory storage medium further includes fourth circuitry executable by the central processing unit to output graphical user interface (GUI) elements representative of the projected elasticity score the historical elasticity score, or both, within a GUI configured to accept a bid on an ad impression of the second ad on the online property.

20. The server computer of claim 19, wherein the non-transitory storage medium further includes fifth circuitry executable by the central processing unit to adjust a received bid on the ad impression of the second ad on the online property, according to the projected elasticity score the historical elasticity score, or both, and
wherein the fourth circuitry is executable by the central processing unit to further output the adjusted bid along with the received bid.
